(19) United States
(12) Patent Application Publication
(10) Pub. No.: US 2026/0210756 A1
(43) Pub. Date: Jul. 23, 2026

(54) DJ TRANSFORM FREQUENCY EXTRACTION METHOD BASED ON ANALYTICAL METHOD

(71) Applicant: BRAINSOFT INC., Seoul (KR)

(72) Inventors: Dong Jin KIM, Seoul (KR); Dong Hoon LEE, Gwangmyeong-si (KR)

(73) Assignee: BRAINSOFT INC., Seoul (KR)

(21) Appl. No.: 19/140,578

(22) PCT Filed: Jul. 21, 2022
(86) PCT No.: PCT/KR2022/010730

§ 371 Date: Jun. 18, 2025

(30) Foreign Application Priority Data
Jul. 27, 2021 (KR) 10-2021-0098796
Nov. 17, 2021 (KR) 10-2021-0158253

(51) Int. Cl. G01H 3/08; G06F 3/16; G06F 17/11

(52) U.S. Cl. CPC G01H 3/08; G06F 3/16; G06F 17/11

(57) ABSTRACT

Proposed is a DJ transform frequency extraction method based on an analytical method. The DJ transform frequency extraction method includes obtaining a damped simple harmonic oscillator linear differential equation in which a linear function acts as an external force; and constructing the linear function as an equation expressed in an integral form of the Dirac delta function; obtaining a solution to an equation for a general external force expressed in an integral form of a Green function; expressing x and v components of the DJT and sine and cosine components of the DJT by integral-form equations of the Green functions, respectively; and expressing the equations for the sine and cosine components of the DJT by a mathematical relationship of Laplace transform and inverse Laplace transform, and reconstructing a given original signal on the basis of the mathematical relationship.

### TECHNICAL FIELD

The present disclosure relates to a method of extracting frequencies constituting a given sound by using a damped harmonic oscillator (DHO), and more particularly, to a DJ transform frequency extraction method based on an analytical method.

### BACKGROUND ART

DJ transform (DJT) using the Green function can be interpreted as the Laplace transform of an external force in the complex domain, and the inverse of the DJT is derived from the inverse Laplace transform. When an external force is applied to a damped harmonic oscillator (DHO), its energy or amplitude of motion depends on the frequency of the external force, and resonance occurs when the frequency of the external force is close to the natural frequency of the damped harmonic oscillator. Therefore, the spectrum of a signal may be analyzed by observing responses of damped harmonic oscillators with different frequencies. The DJT is defined as responses of damped harmonic oscillators (DHOs) with different natural frequencies, substantially ranging from 50 Hz to 8,000 Hz, when a signal acting as an external force is given. The response may be measured in terms of energy or amplitude. The response depends on the natural frequency as well as the damping coefficient, which may be constant or selected in proportion to the frequency of the damped harmonic oscillator. Newton's second law may be expressed by the mathematical relationship as follows.

$$ma = \sum F = - kx - β v + {F}_{ext} ( t ) \qquad [ Equation 1 ]$$

Herein, α=\ddot{x} denotes the acceleration, v=\dot{x} denotes the velocity, −kx denotes the restoring force exerted by the spring, −βv denotes the friction force proportional to the velocity, and Fₑₓₜ denotes the external force. Without loss of generality, other coefficients may be readjusted to set m=1. The equation of motion may then be constructed in a slightly different form as follows.

$$\ddot{x} + 2 β \dot{x} + {ω}^{2} x = {r}_{ω} f ( t ) \qquad [ Equation 2 ]$$

Herein,

$$ω = \sqrt{\frac{k}{m}}$$

denotes the natural frequency of a damped harmonic oscillator. Fₑₓₜ is replaced by r_{ω}f to introduce the response coefficient, r_{ω}. The response coefficient may be set to simply 1 or any other value to normalize responses. For example, when a signal is a sine wave function of a unit amplitude, r_{ω} may be adjusted such that the energy of the damped harmonic oscillator is 1. Hereinafter, 1 is set for convenience. When the damping coefficient is proportional to frequency, the equation of motion is modified as follows.

$$\ddot{x} + 2 βω \dot{x} + {ω}^{2} x = {r}_{ω} f ( t ) \qquad [ Equation 3 ]$$

The DJT of a signal f at time t, [symbol] {f}(t, ω), is defined as the square root of oscillator energy under an external force F as follows.

$$D \{ f \} ( t , ω ) = \sqrt{\frac{1}{2} ( {ω}^{2} {{x}_{ω} ( t )}^{2} + {{v}_{ω} ( t )}^{2} )} \qquad [ Equation 4 ]$$

Then, by solving Equations 2 and 3, [symbol] {f}(t, ω) is obtained as shown above. Solving this for any f needs to depend on a numerical method. Equations 2 and 3 are Inhomogeneous second-order linear differential equations with constant coefficients. These may be numerically solved for any limited f(t) using the Runge-Kutta method. Alternatively, these may be solved with integration using the Green function method. The Green function method describes another aspect of the DJT and proposes a new numerical implementation that leads to a convolution operation. In the meantime, the explicit form of the Green function for the above equations includes an exponential function, and the DJT may be reinterpreted as the Laplace transform of a signal in the complex domain. Herein, the existence of the inverse Laplace transform means that the inverse of the DJT exists under particular assumptions, and an explicit formula for a numerically approximated inverse may be proposed.

When a sine wave signal sin ωt or β^{iωt} is applied, the steady-state solution to Equation 2 may be easily obtained by assuming that the solution is A sin ωt+B cos ωl or Ce^{iωt}. Then, it is straightforward to show that rω=\sqrt{8β} effectively normalizes the solution such that a wave with each frequency ω and unit amplitude generates [symbol] {f}(t, ω) of the same magnitude. By the same reasoning, r_{ω}=\sqrt{8βω} may be used for normalization in Equation 3.

### DISCLOSURE

### Technical Problem

The present disclosure has been devised in consideration of the above-described matters, and the present disclosure is directed to providing a DJ transform frequency extraction method based on an analytical method, the DJ transform frequency extraction method being capable of, when applied to a damped harmonic oscillator (DHO) for frequency extraction, further improving calculation speed and increasing numerical stability at high frequencies by using the analytical method for frequency extraction using a technique, DJ Transform (DJT), developed by the inventors in place of the existing Fourier Transform.

### Technical Solution

According to the present disclosure, there is provided a DJ transform frequency extraction method based on an analytical method
being a method of extracting frequencies by using DJ transform on the basis of the analytical method, the DJ transform frequency extraction method including the steps, each performed by a computer, of:
a) receiving a signal generated from any sound generator and acting as an external force, to generate one linear function corresponding to the signal, and obtaining a damped simple harmonic oscillator linear differential equation in which the generated linear function acts as an external force;
b) replacing an inhomogeneous term of the obtained linear differential equation with a Dirac delta function, and constructing the linear function as an equation expressed in an integral form of the Dirac delta function;
c) obtaining a solution to an equation for a general external force expressed in an integral form of a Green function on the basis of the constructed equation;
d) calculating x(t) and v(t) in the solution to the equation for the general external force by using convolution, and expressing x and v components of the DJT by integral-form equations of the Green functions for proportional damping and uniform damping configurations, respectively;
e) expressing, using the Green functions that vary sinusoidally, sine and cosine components of the DJT by the integral-form equations of the Green functions for the proportional damping and uniform damping configurations, respectively; and
f) expressing the integral-form equations for the sine and cosine components of the DJT by a mathematical relationship of Laplace transform and inverse Laplace transform, and extracting frequencies constituting a given original signal and reconstructing the original signal on the basis of the mathematical relationship.

Herein, preferably, the DJ transform frequency extraction method may further include superimposing the original signal and the reconstructed signal in the step f) to minimize a numerical error therebetween.

In addition, the equation expressed in the integral form of the Dirac delta function in the step b) may be expressed by a mathematical relationship as follows.

$$f ( t ) = \int {dt}^{′} f ( {t}^{′} ) δ ( t - {t}^{′} )$$

Herein, f(t) denotes a function for an external force f, and δ denotes the Dirac delta function.

In addition, the solution to the equation for the general external force in the step c) may include the displacement function x(t) and the velocity function v(t), each using time t as a parameter.

Herein, the x(t) and the v(t) may be respectively expressed by mathematical relationships as follows.

$$\begin{matrix}{x}_{ω} ( t ) = {\int }_{{t}^{′} < t} {dt}^{′} G ( t - {t}^{′} ; β , ω ) f ( {t}^{′} ) \\ {v}_{ω} ( t ) = {\int }_{{t}^{′} < t} {dt}^{′} \dot{G} ( t - {t}^{′} ; β , ω ) f ( {t}^{′} )\end{matrix}$$

Herein, G denotes the Green a function, Ġ denotes derivative of G, β denotes a damping coefficient, and ω denotes a natural frequency of an oscillator.

In addition, the integral-form equations of the Green functions for the x and v components of the DJT in the step d) may be respectively expressed by mathematical relationships as follows.

$${x}_{ω} ( t ) = {D}_{p , u}^{x} \{ f \} ( t , ω ) = \int {dt}^{′} {G}_{p , u}^{x} ( t - {t}^{′} ) f ( {t}^{′} )$$

$${v}_{ω} ( t ) = {D}_{p , u}^{v} \{ f \} ( t , ω ) = \int {dt}^{′} {G}_{p , u}^{v} ( t - {t}^{′} ) f ( {t}^{′} )$$

Herein, D denotes the DJT, subscript p denotes “proportional”, and u denotes “uniform”.

In addition, the integral-form equation of the Green function for the proportional damping configuration of the sine component of the DJT in the step e) may be expressed by a mathematical relationship as follows.

$${D}_{p}^{s} \{ f \} ( t , ω ) = \int {dt}^{′} {G}_{p}^{s} ( t - {t}^{′} ) f ( {t}^{′} )$$

Herein, D denotes the DJT, superscript s denotes sine, and subscript p denotes “proportional”.

### Advantageous Effects

According to the present disclosure as described above, when the present disclosure is applied to a damped harmonic oscillator (DHO) for frequency extraction, calculation speed can be further improved and numerical stability at high frequencies can be increased by using the analytical method for frequency extraction using the technique, DJ Transform (DJT), developed by the inventors in place of the existing Fourier Transform.

### DESCRIPTION OF DRAWINGS

FIG. 1 is a flowchart illustrating a process of executing a method of obtaining a response of a damped harmonic oscillator by using a DJ transform frequency extraction method based on an analytical method according to the present disclosure.

FIGS. 2A and 2B are diagrams illustrating paths of integration for the inverse Laplace transform and inverse DJT.

### MODE FOR INVENTION

The terms and words used in the present specification and claims should not be interpreted as being limited to typical meanings or dictionary definitions, but should be interpreted as having meanings and concepts relevant to the technical scope of the present disclosure based on the rule according to which inventors can appropriately define the concept of the term to describe most appropriately the best method he or she knows for carrying out the disclosure.

Throughout the specification, when a part “includes” an element, it is noted that it further includes other elements, but does not exclude other elements, unless specifically stated otherwise. Also, the terms “ . . . part”, “ . . . unit”, “module”, “device”, and the like mean a unit for processing at least one function or operation and may be implemented by hardware, software, or a combination of hardware and software.

Hereinafter, an embodiment of the present disclosure will be described with reference to the accompanying drawings.

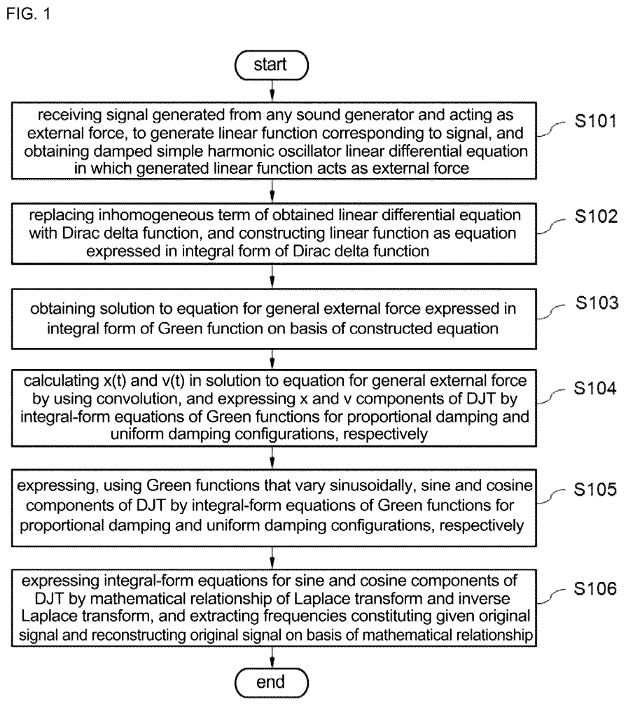

FIG. 1 is a flowchart illustrating a process of executing a DJ transform frequency extraction method based on an analytical method according to an embodiment of the present disclosure.

Referring to FIG. 1, the DJ transform frequency extraction method based on the analytical method according to the present disclosure is a method of extracting frequencies by using DJ transform on the basis of the analytical method, the DJ transform frequency extraction method including steps each performed by a computer. First, a signal generated from any sound generator and acting as an external force is received to generate one linear function corresponding to the signal, and a damped simple harmonic oscillator linear differential equation in which the generated linear function acts as an external force is obtained (step S101).

Next, the inhomogeneous term of the obtained linear differential equation is replaced with the Dirac delta function, and the linear function is constructed as an equation expressed in the integral form of the Dirac delta function (step S102). Herein, the equation expressed in the integral form of the Dirac delta function may be expressed by the mathematical relationship as follows.

$$f ( t ) = \int {dt}^{′} f ( {t}^{′} ) δ ( t - {t}^{′} )$$

Herein, f(t) denotes the function for the external force f, and δ denotes the Dirac delta function.

Afterward, on the basis of the equation constructed in step S102, a solution to the equation for a general external force expressed in the integral form of the Green function is obtained (step S103). Herein, the solution to the equation for the general external force may include a displacement function x(t) and a velocity function v(t), each using time t as a parameter. Herein, x(t) and v(t) may be respectively expressed by the mathematical relationships as follows.

$${x}_{ω} ( t ) = {\int }_{{t}^{′} < t} {dt}^{′} G ( t - {t}^{′} ; β , ω ) f ( {t}^{′} )$$

$${v}_{ω} ( t ) = {\int }_{{t}^{′} < t} {dt}^{′} \dot{G} ( t - {t}^{′} ; β , ω ) f ( {t}^{′} )$$

Herein, G denotes the Green function, G denotes the derivative of G, β denotes the damping coefficient, and w denotes the natural frequency of the oscillator.

Once the solution to the equation for the general external force is obtained, x(t) and v(t) in the solution to the equation for the general external force are calculated using convolution, and the x and v components of the DJT are expressed by integral-form equations of the Green functions for proportional damping and uniform damping configurations, respectively (step S104). Herein, the integral-form equations of the Green functions for the x and v components of the DJT may be respectively expressed by the mathematical relationships as follows.

$${x}_{ω} ( t ) = {D}_{p , u}^{x} \{ f \} ( t , ω ) = \int {dt}^{′} {G}_{p , u}^{x} ( t - {t}^{′} ) f ( {t}^{′} )$$

$${v}_{ω} ( t ) = {D}_{p , u}^{v} \{ f \} ( t , ω ) = \int {dt}^{′} {G}_{p , u}^{v} ( t - {t}^{′} ) f ( {t}^{′} )$$

Herein, D denotes the DJT, the subscript p denotes “proportional”, and u denotes “uniform”.

In addition, using Green functions that vary sinusoidally, sine and cosine components of the DJT are expressed by integral-form equations of the Green functions for proportional damping and uniform damping configurations, respectively (in step S105). Herein, the integral-form equation of the Green function for the proportional damping configuration of the sine component of the DJT may be expressed by the mathematical relationship as follows.

$${D}_{p}^{s} \{ f \} ( t , ω ) = \int {dt}^{′} {G}_{p}^{s} ( t - {t}^{′} ) f ( {t}^{′} )$$

Herein, D denotes the DJT, the superscript s denotes sine, and the subscript p denotes “proportional”.

Afterward, the integral-form equations for the sine and cosine components of the DJT are expressed by the mathematical relationship of the Laplace transform and the inverse Laplace transform, and on the basis of this, the frequencies constituting the given original signal are extracted and the original signal is reconstructed (step S106).

Herein, preferably, step S106 may further include superimposing the original signal and the reconstructed signal to minimize a numerical error therebetween. Details regarding such signal superposition will be described later.

Hereinafter, further descriptions will be provided regarding the DJ transform frequency extraction method based on the analytical method according to the present disclosure.

First, the Green function method and convolution will be described.

### <Green Function Method and Convolution>

The solution to an inhomogeneous linear differential equation may be referred to as a Green function when the inhomogeneous term is given as the Dirac delta function or may be regarded as the impulse response of the equation. For example, when there is a general second-order linear differential equation with the Dirac delta function as an external force, the Green function of the differential equation is defined as a function that satisfies the following equation.

$$a {\ddot{G}}_{p} ( t - {t}_{0} ) + b {\dot{G}}_{p} ( t - {t}_{0} ) + c {G}_{p} ( t - {t}_{0} ) = δ ( t - {t}_{0} ) \qquad [ Equation 5 ]$$

Although the Dirac delta function is not a function in the strict sense, but the Dirac delta function is frequently used to represent an impulse of unit magnitude and may be defined by the following two properties.

$$δ ( t - {t}^{′} ) = 0 if t \neq {t}^{′} \qquad [ Equation 6 ]$$

$${\int }_{- ∞}^{∞} δ ( t - {t}^{′} ) dt = 1$$

The usefulness of the Green function arises from two facts. Any signal or function may be represented as the integral of the Dirac delta function weighted by the linear sum or the function itself, which is a direct result of Equation 6 and may be expressed by the following equation.

$$f ( t ) = \int {dt}^{′} f ( {t}^{′} ) δ ( t - {t}^{′} ) \qquad [ Equation 7 ]$$

On the other hand, an important property of the inhomogeneous linear differential equation is that the solution to an equation with multiple inhomogeneous terms or external forces is a linear combination of the respective solutions to equations containing only individual inhomogeneous terms. Based on these two facts, it may be concluded that the solution to an equation for a general external force f(t) may be represented as an integral of the Green function weighted by the external force f. This may be expressed in an equation as follows.

$${x}_{ω} ( t ) = {\int }_{{t}^{′} < t} {dt}^{′} G ( t - {t}^{′} ; β , ω ) f ( {t}^{′} ) \qquad [ Equation 8 ]$$

The velocity may be obtained in a similar manner in terms of the derivative of the Green function as in the following equation.

$${v}_{ω} ( t ) = {\int }_{{t}^{′} < t} {dt}^{′} \dot{G} ( t - {t}^{′} ; β , ω ) f ( {t}^{′} ) \qquad [ Equation 9 ]$$

Although the integration region is restricted to the region where t′<t, it is not strictly necessary because, as will be shown later, G(t−t′)=0 for the region where t′>t. The dependence of the Green function on β and ω is omitted unless it is necessary to show it explicitly. The detailed form of the Green function will be described later.

Equation 8 and Equation 9 suggest that x(t) and v(t) may be calculated using a convolution operation rather than solving the differential equations. In the deep learning context, the convolution operation is defined somewhat differently. For example, 1D convolution with a kernel size of 2k+1 is defined as follows.

$$Convl d \{ f \} ( t ) = {\sum }_{- k}^{k} {K}_{i} f ( t + i ) \qquad [ Equation 10 ]$$

Herein, it is assumed that a channel dimension is 1. Then, Equation 8 may be re-represented as follows.

$${x}_{ω} ( t ) = \int {dt}^{′′} G ( - {t}^{′′} ) f ( t + {t}^{′′} ) \qquad [ Equation 11 ]$$

Herein, t′ is replaced by t+t″. To reduce the above integral to a convolution operation, the integral needs to be approximated by the sum and the domain needs to be truncated to a finite range. The integral may be approximated by a Riemann sum and the kernel may be truncated to a finite length with almost no error because the Green function decreases exponentially. Using a truncated kernel size k, the numerical formula of the DJT is as follows.

$${x}_{ω} ( t ) = {\sum }_{- k}^{0} {K}_{i} f ( t + i ) \qquad [ Equation 12 ]$$

Equation 11 means that G(−i) may be regarded as the kernel Ki and that summation is performed only for a non-positive number i because G(t)=0 when t<0, and this may be easily implemented by using masked convolution.

Next, frequency-proportional damping and uniform damping will be described.

### <Frequency-Proportional Damping and Uniform Damping>

It is necessary to examine the explicit form of the Green function. When the damping coefficient is proportional to the natural frequency, the equation for the Green function is given as follows.

$${\ddot{G}}_{p} ( t - {t}_{0} ) + 2 βω {\dot{G}}_{p} ( t - {t}_{0} ) + {ω}^{2} {G}_{p} ( t - {t}_{0} ) = δ ( t - {t}_{0} ) \qquad [ Equation 13 ]$$

Herein, the inhomogeneous term on the right-hand side (RHS) represents an impulse at t₀.

It is assumed that β<1 and the subscript p denotes “proportional”. Equation 13 is a second-order linear differential equation with constant coefficients. In addition, it is homogeneous over the entire domain except at t=t₀.

Therefore, it is necessary to separately solve the homogeneous equation for t<0 and t>0, and to match boundary conditions at t=−∞, t=∞, and t=t₀. The solution to the homogeneous equation is an exponentially damped oscillation function. More precisely, it can be assumed as follows as in the following equation.

$$G ( t - {t}_{0} ) = {e}^{- βω t} ( A sin γω t + B cos γω t ) if t - {t}_{0} < {t}_{0} \qquad [ Equation 14 ]$$

$$G ( t - {t}_{0} ) = {e}^{- βω t} ( C sin γω t + D cos γω t ) if t - {t}_{0} > {t}_{0}$$

Herein, γ=\sqrt{1−β²}. The boundary conditions at t=−∞ and t=+∞ are that G(t−t₀) is finite, that is, G cannot be infinite. This is because infinite values cannot exist physically. Herein, A=0 and B=0, and there are no restrictions on C and D. The boundary condition at t=t₀ may be obtained using simple physical intuition. When an impulse occurs at t=t₀, G(t−t₀) needs to be continuous, and there is a jump in the velocity, that is, Ġ(t+0−t₀)−Ġ(t−0−t₀)>0. The magnitude of the jump may be found by integrating the equation of motion from t₀−0 to t₀+0. After the integration, the second and the third term of Equation 13 vanish because the terms are finite and the integration interval is infinitesimally small. In the meantime, the integral of the acceleration term becomes Ġ(t+0−t₀)−Ġ(1−0−t₀)>0 which is equal to 1 because the integral of the RHS is 1. From the continuity condition of G(t−t₀), it can be seen that D vanishes. From the jump in Ġ(t−t₀), it can be seen that

$$C = \frac{1}{γω} .$$

In order to express the Green functions at t<t₀ and t>t₀ in a single formula, a step function θ(t) that vanishes for t<0 and has unit magnitude for t>0 is introduced. Then, G(t−t₀) and Ġ(t−t₀) may be expressed by Equations 15 and 16, respectively.

$${G}_{p} ( t - {t}_{0} ; ω , β ) = θ ( t - {t}_{0} ) \frac{1}{γω} {e}^{- βω ( t - {t}_{0} )} sin γω ( t - {t}_{0} ) \qquad [ Equation 15 ]$$

$${\dot{G}}_{P} ( t - {t}_{0} ; ω , β ) = θ ( t - {t}_{0} ) {e}^{- βω ( t - {t}_{0} )} ( cos γω ( t - {t}_{0} ) - \frac{β}{γ} sin γω ( t - {t}_{0} ) ) \qquad [ Equation 16 ]$$

It is noted that the Green function depends on the natural frequency ω of the oscillator as well as the damping coefficient β.

In the meantime, under the uniform damping condition independent of the oscillator frequency, the Green function is given as a solution to the following equation.

$${\ddot{G}}_{u} ( t - {t}_{0} ) + 2 β {\dot{G}}_{u} ( t - {t}_{0} ) + {ω}^{2} {G}_{u} ( t - {t}_{0} ) = δ ( t - {t}_{0} ) \qquad [ Equation 17 ]$$

Herein, the subscript u denotes “uniform”. This equation is a linear differential equation with constant coefficients, and may be solved using an exponential function. However, unlike the case of proportional damping, β²−ω² is not guaranteed to be negative, and the solution may be oscillatory or purely damped. Therefore, three cases need to be considered. For each case, the functional form of the Green function may be proposed without proof.
1) For β²−ω²<0, the damped natural frequency is given as follows.

$${ω}^{′} = \sqrt{{ω}^{2} - {β}^{2}} \qquad [ Equation 18 ]$$

The solution is a linear combination of two oscillation functions in Equations 19 and 20 with exponential damping.

$${G}_{u} ( t - {t}_{0} ) = θ ( t - {t}_{0} ) \frac{1}{{ω}^{′}} {e}^{- β ( t - {t}_{0} )} sin {ω}^{′} ( t - {t}_{0} ) \qquad [ Equation 19 ]$$

$${\dot{G}}_{u} ( t - {t}_{0} ) = θ ( t - {t}_{0} ) {e}^{- β ( t - {t}_{0} )} ( cos {ω}^{′} ( t - {t}_{0} ) - \frac{β}{{ω}^{′}} sin {ω}^{′} ( t - {t}_{0} ) ) \qquad [ Equation 20 ]$$

2) β²−ω²>0 is the case of overdamping, and the solution is a linear combination of functions such as Equations 21 and 22, which are purely damped.

$${G}_{u} ( t - {t}_{0} ) = θ ( t - {t}_{0} ) \frac{1}{α} {e}^{- β ( t - {t}_{0} )} sinh α ( t - {t}_{0} ) \qquad [ Equation 21 ]$$

$${\dot{G}}_{u} ( t - {t}_{0} ) = θ ( t - {t}_{0} ) {e}^{- β ( t - {t}_{0} )} ( cosh α ( t - {t}_{0} ) - \frac{β}{α} sinh α ( t - {t}_{0} ) ) \qquad [ Equation 22 ]$$

Herein, α=\sqrt{β²−ω²}.
3) β²−ω²=0 is called critical damping. The solution is damped most rapidly and is given by the product of the linear function in Equation 23 and the function exponentially (exponential-function-wise) damped in Equation 24.

$${G}_{u} ( t - {t}_{0} ) = θ ( t - {t}_{0} ) {e}^{- β ( t - {t}_{0} )} ( t - {t}_{0} ) \qquad [ Equation 23 ]$$

$${\dot{G}}_{u} ( t - {t}_{0} ) = θ ( t - {t}_{0} ) {e}^{- β ( t - {t}_{0} )} ( 1 - β ( t - {t}_{0} ) ) \qquad [ Equation 24 ]$$

Next, sinusoidal decomposition will be described.

### <Sinusoidal Decomposition>

From Equations 8 and 9 above, it can be seen that G and G act as kernels for x and v, respectively. Therefore, these may be referred to as G^{x} and G^{v}, respectively. It is necessary to identify the forms of G^{x} and G^{v}. Then, x(t) and v(t) may be calculated using convolution. Then, the x and v components of the DJT may be defined, respectively, by Equations 25 and 26 for proportional and uniform damping configurations.

$${x}_{ω} ( t ) = {D}_{p , u}^{X} \{ f \} ( t , ω ) = \int {dt}^{′} {G}_{p , u}^{x} ( t - {t}^{′} ) f ( {t}^{′} ) \qquad [ Equation 25 ]$$

$${v}_{ω} ( t ) = {D}_{p , u}^{v} \{ f \} ( t , ω ) = \int {dt}^{′} {G}_{p , u}^{v} ( t - {t}^{′} ) f ( {t}^{′} ) \qquad [ Equation 26 ]$$

Herein, if omitting the subscripts p and u does not cause confusion, the subscripts p and u may be omitted.

At times, it is convenient to separate the cosine and sine components of the Green function. In the case of proportional damping, the Green function varying in the form of a sine wave may be defined as shown in Equations 27 and 28.

$${G}_{p}^{s} ( t - {t}_{0} ) = θ ( t - {t}_{0} ) {e}^{- βω ( t - {t}_{0} )} sin γω ( t - {t}_{0} ) \qquad [ Equation 27 ]$$

$${G}_{p}^{c} ( t - {t}_{0} ) = θ ( t - {t}_{0} ) {e}^{- βω ( t - {t}_{0} )} cos γω ( t - {t}_{0} ) \qquad [ Equation 28 ]$$

Herein,

$${G}_{p}^{x} and {G}_{p}^{v}$$

may be expressed in terms of

$${G}_{p}^{s} and {G}_{p}^{c}$$

as shown in Equations 29 and 30.

$${G}_{p}^{x} = \frac{1}{γω} {G}_{p}^{s} \qquad [ Equation 29 ]$$

$${G}_{p}^{v} = {G}_{p}^{c} - \frac{β}{γ} {G}_{p}^{s} \qquad [ Equation 30 ]$$

For uniform damping, three cases need to be considered. When the damping coefficient is sufficiently small such that the Green function is oscillatory, the Green functions varying in the form of a sine wave are defined as shown in Equations 31 and 32.

$${G}_{u}^{s} ( t - {t}_{0} ) = θ ( t - {t}_{0} ) {e}^{- β ( t - {t}_{0} )} sin {ω}^{′} ( t - {t}_{0} ) \qquad [ Equation 31 ]$$

$${G}_{u}^{c} ( t - {t}_{0} ) = θ ( t - {t}_{0} ) {e}^{- β ( t - {t}_{0} )} cos {ω}^{′} ( t - {t}_{0} ) \qquad [ Equation 32 ]$$

Herein, ω′ is \sqrt{ω²−β²} as described above. In the case of overdamping, the function forms of

$${G}_{u}^{s} and {G}_{u}^{c}$$

remain almost identical except that the sine and cosine functions need to be replaced with hyperbolic sine and hyperbolic cosine. The relationship between

$${G}_{u}^{x , v} and {G}_{u}^{s , c}$$

is shown in Equations 33 and 34.

$${G}_{u}^{x} = \frac{1}{{ω}^{′}} {G}_{u}^{s} \qquad [ Equation 33 ]$$

$${G}_{u}^{v} = {G}_{u}^{c} - \frac{β}{{ω}^{′}} {G}_{u}^{s} \qquad [ Equation 34 ]$$

Using the Green functions varying in the form of a sine wave, the sine and cosine components of the DJT may be defined as shown in Equation 35, and

$${D}_{p}^{c} \{ f \} , {D}_{u}^{s} \{ f \} , and {D}_{u}^{c} \{ f \}$$

may be defined in the same manner.

$${D}_{p}^{s} \{ f \} ( t , ω ) = \int {dt}^{′} {G}_{p}^{s} ( t - {t}^{′} ) f ( {t}^{′} ) \qquad [ Equation 35 ]$$

As another representation of the DJT,

$${D}_{p}^{s , c} and {D}_{u}^{s , c}$$

may be considered. This is because these are related to

$${D}_{p}^{x , v} and {D}_{u}^{x , v}$$

in the same manner as Equations 30 and 34, respectively.

Next, the DJT will be described in terms of the Laplace transform and the inverse Laplace transform.

### <DJT in Terms of the Laplace Transform and the Inverse Laplace Transform>

### Sinusoidal DJT and the Laplace Transform

The Laplace transform is integral transform that converts a function of a positive real number variable t into a function of a complex variable s, and is defined as follows.

$$L \{ f \} ( s ) = {\int }_{0}^{∞} f ( t ) {e}^{- st} dt \qquad [ Equation 36 ]$$

Herein, L{f} denotes the Laplace transform of f. The Laplace transform of a function no longer depends on t. This contrasts with the fact that the DJT depends on frequency as well as time. The DJT at a fixed time t may be expressed by the Laplace transform with a complex number s having a positive real part. Herein, first,

$${D}_{p}^{s} \{ f \} ,$$

expressed by the following mathematical relationship, is considered.

$${D}_{p}^{s} \{ f \} ( t , ω ) = \int {dt}^{′} {G}_{p}^{s} ( t - {t}^{′} ) f ( {t}^{′} ) = \int {dt}^{′} θ ( t - {t}^{′} ) {e}^{- βω ( t - {t}^{′} )} sin γω ( t - {t}^{′} ) f ( {t}^{′} ) = \int {dt}^{″} θ ( {t}^{″} ) {e}^{- βω {t}^{″}} sin γω {t}^{″} f ( t - {t}^{″} ) = \frac{1}{2 i} {\int }_{0}^{∞} {dt}^{′} ( {e}^{- ( β - i γ ) ω {t}^{′}} - {e}^{- ( β + γ ) ω {t}^{′}} ) f ( t - {t}^{′} ) \qquad [ Equation 37 ]$$

When f̅ is defined as f̅ₜ(t′)=(t−t′), the last line of Equation 37 may be re-represented as follows.

$${D}_{p}^{s} \{ f \} ( t , ω ) = \frac{1}{2 i} ( L \{ \overline{{f}_{t}} \} ( ( β - i γ ) ω ) - L \{ \overline{{f}_{t}} \} ( ( β + i γ ) ω ) ) \qquad [ Equation 38 ]$$

Similarly,

$${D}_{P}^{c} \{ f \} , {D}_{u}^{s} \{ f \} , and {D}_{u}^{c} \{ f \}$$

may be expressed by Equations 39, 40, and 41 in terms of the Laplace transform.

$${D}_{p}^{c} \{ f \} ( t , ω ) = \frac{1}{2} ( L \{ \overline{{f}_{t}} \} ( ( β - i γ ) ω ) + L \{ \overline{{f}_{t}} \} ( ( β + i γ ) ω ) ) \qquad [ Equation 39 ]$$

$${D}_{u}^{s} \{ f \} ( t , ω ) = \frac{1}{2 i} ( L \{ \overline{{f}_{t}} \} ( β - i {ω}^{′} ) - L \{ \overline{{f}_{t}} \} ( β + i {ω}^{′} ) ) \qquad [ Equation 40 ]$$

$${D}_{u}^{c} \{ f \} ( t , ω ) = \frac{1}{2} ( L \{ \overline{{f}_{t}} \} ( β - i ω ) + L \{ \overline{{f}_{t}} \} ( β + i {ω}^{′} ) ) \qquad [ Equation 41 ]$$

From these, the Laplace transform of f̅ₜ, may be expressed by a linear combination of sinusoidal DJTs as shown in Equations 42 and 43.

$$\begin{matrix}L \{ \overline{{f}_{t}} \} ( ( β + i γ ) ω ) = {D}_{p}^{c} \{ f \} ( t , ω ) - {iD}_{p}^{s} \{ f \} ( t , ω ) \\ L \{ \overline{{f}_{t}} \} ( ( β - i γ ) ω ) = {D}_{p}^{c} \{ f \} ( t , ω ) + {iD}_{p}^{s} \{ f \} ( t , ω )\end{matrix} \qquad [ Equation 42 ]$$

$$\begin{matrix}L \{ \overline{{f}_{t}} \} ( β + i {ω}^{′} ) = {D}_{u}^{c} \{ f \} ( t , ω ) - {iD}_{u}^{s} \{ f \} ( t , ω ) \\ L \{ \overline{{f}_{t}} \} ( β - i {ω}^{′} ) = {D}_{u}^{c} \{ f \} ( t , ω ) + {iD}_{u}^{s} \{ f \} ( t , ω )\end{matrix} \qquad [ Equation 43 ]$$

the inventors have considered only oscillation Green functions with uniform damping, and such oscillation Green functions may be sufficient for reconstructing the original signal f from the DJT of f. However, the application is not limited to the oscillation Green functions with uniform damping, and may be extended and applied to oscillation Green functions with overdamping or critically damping.

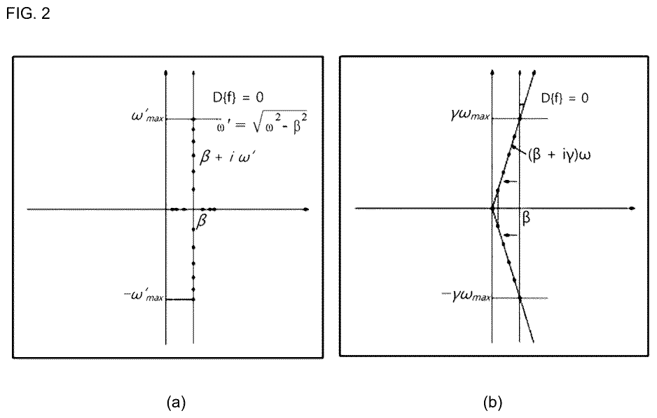

FIG. 2 show diagrams illustrating paths of integration for the inverse Laplace transform and inverse DJT.

Referring to FIG. 2, (a) shows a path of integration of uniform damping, and this path of integration is a vertical line. Equation 43 above shows that the values (dots) are unevenly positioned. (b) shows a path of integration of proportional damping, and this path of integration is a discretely straight line. Equation 42 above shows that the values (dots) are evenly spaced.

### Inverse of DJT

The inverse of the Laplace transform may be obtained from Mellin's formula as follows.

$$f ( t ) = {L}^{- 1} \{ F ( s ) \} = \frac{1}{2 π i} {\int }_{β - i ∞}^{β + i ∞} {e}^{st} F ( s ) ds \qquad [ Equation 44 ]$$

Herein, F(s) denotes the Laplace transform of f, and β is a particular real number for all poles of F(s) to be positioned to the left of the integration line. Since the Laplace transform of a physical signal has no poles with a non-negative real part, any positive number serve as β. When the DTS of f exists for all ω along the path of integration, f(t) may be identified by evaluating the above integral. Even if the DJT exists only at discrete frequencies within a limited range, the inverse of the DJT may be practically calculated by assuming that the integral is replaced with a sum because the frequencies of the DJT are sufficiently dense and that F(s) becomes 0 outside the frequency region of the DJT. The second assumption above is justified by the “Nyquist-Shannon” sampling theorem as long as the frequency range of the DJT is up to the Nyquist frequency and the signal f is recovered from

$${𝒟}_{p}^{s , c} or {𝒟}_{u}^{s , c} .$$

FIG. 2 shows that the path of integration for inverse transform and the positions of the values of L{f}.
Inverse of DJT with Uniform Damping

Using Equations 43 and 44, f̅ₜ may be obtained from the DJT with uniform damping. (a) of FIG. 2 shows that the path of integration is a vertical line from β−i∝ to β+i∝ and Equation 44 may be used to calculate the inverse of the DJT. Equation 43 shows that the integral may be parameterized by and the values of are not evenly spaced. Since is 0 outside, the integration region may be limited from the positive Nyquist frequency to the negative Nyquist frequency. ds=d(β+iω′) becomes idω′. It is assumed that F̅ₜ denotes the Laplace transform of f̅ₜ. Then, this may be expressed by the following mathematical relationship.

$$\begin{matrix}\overline{{f}_{t}} ( {t}^{′} ) = f ( t - {t}^{′} ) = \frac{1}{2 π} {\int }_{∞}^{+ ∞} {e}^{( β + i {ω}^{′} ) {t}^{′}} \overline{{F}_{t}} ( β + i {ω}^{′} ) d {ω}^{′} \\ = \frac{1}{2 π} \{ {\int }_{∞}^{+ ∞} {e}^{( β + i {ω}^{′} ) {t}^{′}} \overline{{F}_{t}} ( β + i {ω}^{′} ) d {ω}^{′} + {\int }_{∞}^{+ ∞} {e}^{( β + i {ω}^{′} ) t′} {F}_{t} ( β + i {ω}^{′} ) d {ω}^{′} \} \\ = \frac{1}{2 π} \{ {\int }_{∞}^{+ ∞} {e}^{β {t}^{′}} ( ( {e}^{i {ω}^{′} {t}^{′}} + {e}^{- i {ω}^{′} {t}^{′}} ) {D}_{u}^{c} \{ f \} ( t , ω ) - i ( {e}^{i {ω}^{′} {t}^{′}} - {e}^{- i {ω}^{′} {t}^{′}} ) {D}_{u}^{s} \{ f \} ( t , ω ) ) d {ω}^{′} \\ = \frac{1}{π} {\int }_{∞}^{+ ∞} {e}^{β {t}^{′}} ( cos {ω}^{′} {t}^{′} {D}_{u}^{c} \{ f \} ( t , ω ) + sin {ω}^{′} {t}^{′} {D}_{u}^{s} \{ f \} ( t , ω ) ) d {ω}^{′}\end{matrix} \qquad [ Equation 45 ]$$

Herein, ω′=\sqrt{ω²−β²} is maintained and f̅ₜ is defined as f̅ₜ(t′)=f(t−t′) as described above. Now, the integration region may be limited to the Nyquist frequency range and approximated by a summation. In general, the DJT is performed for integer-valued frequencies because Δf=1. This implies the following.

$${Δω}^{′} = \frac{2 ωΔω}{2 \sqrt{{ω}^{2} - {β}^{2}}} = \frac{2 πωΔ f}{{ω}^{′}} = \frac{2 πω}{{ω}^{′}} \qquad [ Equation 46 ]$$

Then, the above integral may be approximated by a summation as shown in Equations 47 and 48.

$$\begin{matrix}f ( t - {t}^{′} ) = \frac{1}{π} {\sum }_{{ω}_{min}}^{{ω}_{max}} {e}^{β {t}^{′}} ( cos {ω}^{′} {t}^{′} {D}_{u}^{c} \{ f \} ( t , ω ) + sin {ω}^{′} {t}^{′} {D}_{u}^{s} \{ f \} ( t , ω ) ) \frac{2 πω}{{ω}^{′}} \\ = 2 {\sum }_{{ω}_{min}}^{{ω}_{max}} {e}^{β {t}^{′}} ( cos {ω}^{′} {t}^{′} {D}_{u}^{c} \{ f \} ( t , ω ) + sin {ω}^{′} {t}^{′} {D}_{u}^{s} \{ f \} ( t , ω ) ) \frac{ω}{{ω}^{′}}\end{matrix} \qquad [ Equation 47 ]$$

$$f ( {t}^{′} ) = 2 {\sum }_{{ω}_{min}}^{{ω}_{max}} {e}^{β ( t - {t}^{′} )} ( cos {ω}^{′} ( t - {t}^{′} ) {D}_{u}^{c} \{ f \} ( t , ω ) + sin {ω}^{′} ( t - {t}^{′} ) {D}_{u}^{s} \{ f \} ( t , ω ) ) \frac{ω}{{ω}^{′}} \qquad [ Equation 48 ]$$

Herein, ωₘᵢₙ is the lowest angular frequency of the oscillation kernel rather than 0. Equation 48 is a simple form of the inverse DJT and may be improved by a general algorithm for performing numerical integration.

Since the Laplace transform encodes the entire function, the entire function may be recovered as long as sufficient values of the Laplace transform are available to perform integration in Equation 44. From Equation 48, it can be seen that the DJT result at time t for t>t′ is available, f(t′) may be recovered at time t′. Therefore, when the DJT result composed of continuous frequencies is available at the final moment of the signal, the entire signal may be recovered, but this is not practical. Another issue in numerical calculations arises due to the factors e^{βt′} and e^{-βt′}. Since is multiplied by f in the DJT, the contribution of f(t−t′) is suppressed to nearly 0 for large t′. When the inverse DJT is performed, e^{βt′} is multiplied again and the original signal is recovered. However, numerical errors are amplified in this process, and a solution to this problem using an overlapping method is described later.

Inverse of DJT with Proportional Damping

(b) of FIG. 2 shows the path of integration and the positions of the L{f} values. This path is now a discretely straight line connecting (β−iγ)∞, 0, and (β+iγ)∞. The path of integration needs to be transformed from the vertical line to this path in order to apply Equation 44. It is assumed that f and L{f} are both complex analytic functions. However, experiments show that the formula for the inverse DJT also works well even for non-analytic f. If f is analytic, a vertical line segment connecting (β−iγ)ωₘₐₓ and (β+iγ)ωₘₐₓ may be transformed into a discretely straight line having the same start and end points and passing through the origin of the complex plane in the middle. However, there must be no poles in the region bounded by the paths, but this condition is applied to all physical signals, so path deformation is possible. In the range from (β+iγ)ωₘₐₓ to (β+iγ)∞, the integrand vanishes by the Nyquist-Shannon sample theorem, so the line from (β+iγ)ωₘₐₓ to (γ+iγ)∞ may be transformed into a vertical line starting from (β+iγ)ωₘₐₓ. Then, Equations 44 and 42 may be used to obtain f̅ₜ from as follows.

$$\begin{matrix}\overline{{f}_{t}} ( {t}^{′} ) = f ( t - {t}^{′} ) = \frac{1}{2 π i} \{ \int \text{?} \text{?} \text{?} \text{?} \\ = \frac{1}{2 π i} \{ \int \text{?} \text{?} \text{?} \text{?} \\ = \frac{1}{2 π i} \{ \int \text{?} \text{?} \text{?} \text{?} \\ = \frac{1}{π} \{ \int \text{?} \text{?} \text{?} \text{?}\end{matrix}$$

$$\text{?} \text{indicates text missing or illegible when filed}$$

Herein, the above integration range is limited to the Nyquist frequency, and may be approximated by a summation as follows.

$$f ( {t}^{′} ) = 2 {\sum }_{{ω}_{1}}^{{ω}_{max}} {e}^{βω ( t - {t}^{′} )} \{ ( γ cos γω ( t - {t}^{′} ) + β sin γω ( t - {t}^{′} ) ) {𝒟}_{p}^{c} \{ f \} ( t , ω ) + ( - β cos γω ( t - {t}^{′} ) + γ sin γω ( t - {t}^{′} ) ) {𝒟}_{p}^{s} \{ f \} ( t , ω ) \} + γ {𝒟}_{p}^{c} \{ f \} ( t , 0 ) - β {𝒟}_{p}^{s} ( t , 0 ) \qquad [ Equation 50 ]$$

In Equation 50 above, the last term corresponding to the zero frequency needs to be processed carefully. The solution to Equation 3 at ω=0 diverges because both the restoring force and the friction force disappear. Instead, the DJT at the zero frequency may simply be defined as follows.

$$\begin{matrix}{D}_{p}^{s} \{ f \} ( t , 0 ) = 0 \\ {D}_{p}^{c} \{ f \} ( t , 0 ) = {\int }_{{t}^{′} < t} {dt}^{′} {e}^{- ε ( t - {t}^{′} )} f ( {t}^{′} )\end{matrix} \qquad [ Equation 51 ]$$

This slightly modifies the Green function to have a small damping coefficient ε. When ϵ=2πβ is selected, the path becomes a path that bypasses the origin while excluding zero and directly connects the lowest frequency pair, (β−iγ)ω₁ and (β+iγ)ω₁, in (b) of FIG. 2.

Next, signal superposition will be described.

### <Signal Superposition>

Instead of reconstructing the entire signal from the DJT result at a single time point, DJT results from multiple moments may be used regardless of whether the moments are temporally equally spaced, and the inverse DJT is performed to obtain the original signal. Since f(t) is calculated multiple times using DJT results from time points later than t, the values of f(t) needs to be averaged in some manner. A simple average is not after averaging, large numerical appropriate because even errors may still occur.

### 1) Overlap Addition Method

From the formula for the inverse DJT, f(t′) may be obtained from all DJTs calculated at t>t′, and in principle, these need to be the same value. However, numerical errors increase as t−t′ increases. One way to avoid this problem is to use a weighted average together with an appropriate weight function. A simple choice is a function that decreases exponentially with t−t′, for example, a function for a particular δ as follows.

$$W ( t - {t}^{′} ) = {e}^{- δ ( t - {t}^{′} )} \qquad [ Equation 52 ]$$

Herein, a weighted overlap signal may be expressed by the following mathematical relationship.

$$\overline{f} ( {t}^{′} ) = {\sum }_{t} W ( t - {t}^{′} ) {f}_{t} ( {t}^{′} ) / {\sum }_{t} W ( t - {t}^{′} ) \qquad [ Equation 53 ]$$

Herein, fₜ(t′) is f(t′) obtained from the inverse DJT calculated at time t. For example, in the case of proportional damping as shown in Equation 54, when δ is greater than β, this works well in the case of uniform damping. In the case of proportional damping, when δ is set to βωₘₐₓ, the weight function is damped sufficiently fast to suppress terms that are prone to numerical errors.

$$f ( {t}^{′} ) = {\sum }_{t} 2 {e}^{- δ ( t - {t}^{′} )} {\sum }_{{ω}_{min}}^{{ω}_{max}} {e}^{βω ( t - {t}^{′} )} \{ ( γ cos γω ( t - {t}^{′} ) + β sin γω ( t - {t}^{′} ) ) {𝒟}_{u}^{c} \{ f \} ( t , ω ) + ( - β cos γω ( t - {t}^{′} ) + γ sin γω ( t - {t}^{′} ) ) {𝒟}_{u}^{s} \{ f \} ( t , ω ) \} / {\sum }_{t} {e}^{- δ ( t - {t}^{′} )} \qquad [ Equation 54 ]$$

### 2) Griffin-Lim Style Overlap

Since the DJT with uniform damping shares the same exponential damping coefficient e^{-βt} regardless of frequency, a numerically more stable method for overlapping signals may be considered. Equation 47 may be re-represented as follows.

$$\begin{matrix}f ( {t}^{′} ) = \frac{2}{{e}^{- β ( t - {t}^{′} )}} {\sum }_{{ω}_{min}}^{{ω}_{max}} ( cos {ω}^{′} ( t - {t}^{′} ) {D}_{u}^{c} ( t , ω ) + sin {ω}^{′} ( t - {t}^{′} ) {D}_{u}^{s} \{ f \} ( t , ω ) ) \frac{ω}{{ω}^{′}} \\ = \frac{2}{{e}^{- 2 β ( t - {t}^{′} )}} {\sum }_{{ω}_{min}}^{{ω}_{max}} {e}^{- β ( t - {t}^{′} )} ( cos {ω}^{′} ( t - {t}^{′} ) {D}_{u}^{c} \{ f \} ( t , ω ) + sin {ω}^{′} ( t - {t}^{′} ) {D}_{u}^{s} \{ f \} ( t , ω ) ) \frac{ω}{{ω}^{′}}\end{matrix} \qquad [ Equation 55 ]$$

The first and the second expression correspond to δ=β and δ=2β, respectively. Using the second formula, the overlap-addition signal may be expressed as follows.

$$f ( {t}^{′} ) = {\sum }_{t} 2 {\sum }_{{π}_{min}}^{{ω}_{max}} {e}^{- β ( t - {t}^{′} )} ( cos {ω}^{′} ( t - {t}^{′} ) {D}_{u}^{c} \{ f \} ( t , ω ) + sin {ω}^{′} ( t - {t}^{′} ) {D}_{u}^{s} \{ f \} ( t , ω ) ) \frac{ω}{{ω}^{′}} / {\sum }_{t} {e}^{- 2 β ( t - {t}^{′} )} \qquad [ Equation 56 ]$$

This form of superposition method is derived from the Griffin-Lim algorithm to minimize the mean square error between the original signal and the reconstructed signal. In the context of numerical calculation, the terms with large numerical errors due to large (t−t′) are suppressed by the multiplication of e^{-β(t-t′)} and compensation is made in the denominator by adding e^{-2β(t-t′)} instead of e^{-β(t-t′)} in the denominator.

### CONCLUSION

The inventors' consideration started from the physical definition of the DJT as the response of a damped harmonic oscillator (DHO) to a signal acting as an external force. The DJT result at any time point may be obtained by numerically solving the equation of motion using the Runge-Kutta method. Instead, the inventors investigated the Green function method and expressed the solution as a convolution integral of the signal and the Green function of the equation. The resulting formula was modified into a summation and transformed into a convolution operation in the deep learning context. In addition, the calculation speed was significantly improved compared to the Runge-Kutta method, and numerical stability was enhanced at high frequencies.

At higher frequencies, there are relatively fewer signal samples within one cycle of frequency in a given input signal. In the case of high frequencies, the slope used in the Runge-Kutta method needs to be estimated from relatively few samples, which appears to cause large numerical errors at high frequencies. In contrast, the Green function method involves summation over the samples, and since the estimated slope of the samples is not used, numerical errors are not amplified at high frequencies.

Finally, the DJT with real-valued frequencies is regarded as the Laplace transform in the complex domain. Herein, Mellin's formula was used to obtain the inverse of the DJT through the inverse Laplace transform. The numerical algorithm was implemented using a convolution operation for the efficiency of calculation.

As described above, the DJ transform frequency extraction method based on the analytical method according to the present disclosure can, when applied to a damped simple harmonic oscillator (DHO) for frequency extraction, further improve calculation speed and increase numerical stability at high frequencies by using the analytical method for frequency extraction using the technique, DJ Transform (DJT) developed by the inventors in place of the existing Fourier Transform.

Although an exemplary embodiment of the present disclosure has been described in detail, the present disclosure is not limited thereto, and it is obvious to those skilled in the art that various modification and applications can be made within the scope of the technical idea of the present disclosure. Accordingly, the true scope of the present disclosure should be interpreted by the following claims, and all technical ideas within the scope equivalent thereto should be interpreted as being included in the scope of the present disclosure.

1. A DJ transform frequency extraction method based on an analytical method, the DJ transform frequency extraction method being a method of extracting frequencies by using DJ transform on the basis of the analytical method and comprising the steps, each performed by a computer, of:
a) receiving a signal generated from any sound generator and acting as an external force, to generate one linear function corresponding to the signal, and obtaining a damped simple harmonic oscillator linear differential equation in which the generated linear function acts as an external force;
b) replacing an inhomogeneous term of the obtained linear differential equation with Dirac delta function, and constructing the linear function as an equation expressed in an integral form of the Dirac delta function;
c) obtaining a solution to an equation for a general external force expressed in an integral form of a Green function on the basis of the constructed equation;
d) calculating x(t) and v(t) in the solution to the equation for the general external force by using convolution, and expressing x and v components of the DJT by integral-form equations of the Green functions for proportional damping and uniform damping configurations, respectively;
e) expressing, using the Green functions that vary sinusoidally, sine and cosine components of the DJT by the integral-form equations of the Green functions for the proportional damping and uniform damping configurations, respectively; and
f) expressing the integral-form equations for the sine and cosine components of the DJT by a mathematical relationship of Laplace transform and inverse Laplace transform, and extracting frequencies constituting a given original signal and reconstructing the original signal on the basis of the mathematical relationship.

2. The DJ transform frequency extraction method of claim 1, further comprising
superimposing the original signal and the reconstructed signal in the step f) to minimize a numerical error therebetween.

3. The DJ transform frequency extraction method of claim 1, wherein
the equation expressed in the integral form of the Dirac delta function in the step b) is expressed by a mathematical relationship as follows,
$$f ( t ) = \int {dt}^{′} f ( {t}^{′} ) δ ( t - {t}^{′} )$$
herein, f(t) denotes a function for an external force f, and δ denotes the Dirac delta function.

4. The DJ transform frequency extraction method of claim 1, wherein
the solution to the equation for the general external force in the step c) includes the displacement function x(t) and the velocity function v(t), each using time t as a parameter.

5. The DJ transform frequency extraction method of claim 4, wherein
the x(t) and the v(t) are respectively expressed by mathematical relationships as follows,
$$\begin{matrix}{x}_{ω} ( t ) = {\int }_{{t}^{′} < t} {dt}^{′} G ( t - {t}^{′} ; β , ω ) f ( {t}^{′} ) \\ {v}_{ω} ( t ) = {\int }_{{t}^{′} < t} {dt}^{′} \dot{G} ( t - {t}^{′} ; β , ( ω ) f ( {t}^{′} )\end{matrix}$$
herein, G denotes the Green function, Ġ denotes a derivative of G, β denotes a damping coefficient, and ω denotes a natural frequency of an oscillator.

6. The DJ transform frequency extraction method of claim 1, wherein
the integral-form equations of the Green functions for the x and v components of the DJT in the step d) are respectively expressed by mathematical relationships as follows,
$$\begin{matrix}{x}_{ω} ( t ) = {D}_{p , u}^{x} \{ f \} ( t , ω ) = \int {dt}^{′} {G}_{p , u}^{x} ( t - {t}^{′} ) f ( {t}^{′} ) \\ {v}_{ω} ( t ) = {D}_{p , u}^{v} \{ f \} ( t , ω ) = \int {dt}^{′} {G}_{p , u}^{v} ( t - {t}^{′} ) f ( {t}^{′} )\end{matrix}$$
herein, D denotes the DJT, subscript p denotes “proportional”, and u denotes “uniform”.

7. The DJ transform frequency extraction method of claim 1, wherein
the integral-form equation of the Green function for the proportional damping configuration of the sine component of the DJT in the step e) is expressed by a mathematical relationship as follows,
$${D}_{p}^{s} \{ f \} ( t , ω ) = \int {dt}^{′} {G}_{p}^{s} ( t - {t}^{′} ) f ( {t}^{′} )$$
herein, D denotes the DJT, superscript s denotes sine, and subscript p denotes “proportional”.
